(19) United States
(12) Patent Application Publication
(10) Pub. No.: US 2014/0337880 A1
(43) Pub. Date: Nov. 13, 2014

(54) Peer-to-Peer Communication Advertising Method

(71) Applicants: Shayna Sorbel, Newport Beach, CA (US); Floyd Kaylor, Yorba Linda, CA (US)

(72) Inventors: Shayna Sorbel, Newport Beach, CA (US); Floyd Kaylor, Yorba Linda, CA (US)

(21) Appl. No.: 13/889,899

(22) Filed: May 8, 2013

(51) Int. Cl. H04N 21/81; H04N 21/478; H04N 21/435

(52) U.S. Cl. CPC H04N 21/812; H04N 21/435; H04N 21/478
USPC 725/34

(57) ABSTRACT

The present disclosure relates to a system is designed to adapt to changing viewer behavior by detecting Peer-To-Peer communications, or other Skype or Skype-like communication during streaming video content (e.g., commercial, movie, television show, sponsored content, live or recorded, etc.) viewed on a TV, monitor, Laptop, tablet, computerized watch or computerized glasses. The present invention incorporates a logo graphic, watermark, banner, video, and the like (with or without static, 3-D, sound, picture-in-picture etc.) or other message over the streaming video content onto the background. This graphic displays the advertiser's brand message to achieve a brief imprint on the viewer. The DAI augments the linear spot so the advertiser can reach their intended target audience.

### FIELD OF THE INVENTION

The present invention relates generally to a television, computer, cell phone, Tablet or similar apparatus advertising method. More specifically the present invention is an advertising method which uniquely identifies streaming video content (e.g., commercials, movies, television shows, sponsored material, live or recorded, etc.) and incorporates the advertiser's assets logo, graphic, watermark, banner, video, and the like (with or without static, 3-D, sound, picture-in-picture, etc.) in a strategic, nonintrusive and predetermined or designated area in the foreground within or outside the video chat session, during a peer-to-peer conversation such as Skype,

### BACKGROUND OF THE INVENTION

Manufactures, service providers and broadcasters rely on advertising to convey information about their products, services special offers (promotions and contest), directions to the showrooms, advantages of their technology or services just to name of few. Marketing and advertising is a well-developed curriculum that utilizes strategy and information to convey persuasive information to maintain, cultivate, or mature the business. Current methods and products on the market may provide a method for advertising during typical television commercial breaks, but none currently on the market provide a method for advertising which uniquely identifies streaming video content and incorporates the advertiser's assets: logo, graphic, watermark, banner, video, and the like with or without static, 3-D, sound, picture-in-picture, etc.) in a strategic, nonintrusive and predetermined or designated area within or outside the video chat, such as Slope-type foreground, during a peer-to-pee conversation.

### SUMMARY OF THE INVENTION

The present disclosure relates to a method and apparatus designed to uniquely identify streaming video content and incorporates the advertiser's assets: logo, graphic, watermark, banner, video, and the like (with or without static, 3-D, sound, picture-in-picture, etc.) in a strategic, nonintrusive and predetermined or designated area within or outside the video chat, such as Skype, foreground during a peer-to-peer conversation. The present invention provides a unique and creative solution to recapture the viewer's attention while still engaged in their peer-to-peer conversation.

The present invention comprises of five (5) components: a standard set-top box (STB) or equivalent, peer-to-peer (P2P) Video Buddy box with Skype-like Video CHAT Technology or an equivalent, Webcam/camera module or equivalent, the Ad Server Software Stacker, and “The Digital Air Impressions” (DAI) Ad Video Recognition Software.

The present invention is for use with a television or monitor that uses a set-top box or an equivalent, the peer-to-peen video buddy box with Skype application or equivalent. As a user watches television and during a peer-to-peer (Skype or Skype-like) conversation, the streaming video content (e.g., commercial, movie, television show, sponsored material, live or recorded, etc.) played in the television background while the “Digital Air Impression” of the advertiser's assets: logo, graphic, watermark, banner, video, and the like (with or without static, 3-D, sound, tune-in-picture, etc.) appears and is incorporated within the streaming video content to a predetermined or designated area on the screen. The present invention is also for use on smart phones, tablets, computerized watches and computerized glasses or any apparatus that has Skype or Skype-like capabilities.

The Digital Air Impressions (DAI) Ad Video Recognition Software has the logic to identify what is playing on the screen. Once it identifies the streaming video content, it searches the DAI Ad Server Library (Asset Library) to look for and match the appropriate advertiser's assets: logo, graphic, watermark, banner, video, and the like (with or without static, 3-D, sound, picture-in-picture, etc.) and then incorporates it onto a predetermined or designated area on the screen in a strategic, non-intrusive location within or outside of the video chat (e.g., Skype, FaceTime, Google Tack, iChat, and the like) foreground during a peer-to-peer conversation. Note: The DAI Ad Server Library (Asset Library) is stored inside the DAI Ad Video Recognition Software.

The present invention uniquely identifies streaming video content and incorporates the advertiser's assets: logo, graphic, watermark, banner, video, and the like (with or without static, 3-D, sound, picture-in-picture, etc.) in a strategic, nonintrusive and predetermined or designated location within or outside of the video chat, such as a Skype or Skype-type foreground during a peer-to-peer conversation.

Although the invention has been explained in relation to its preferred embodiment, it is to be understood that many other possible modifications and variations can be made without departing from the spirit and scope of the invention as herein described.

### BRIEF DESCRIPTION OF THE DRAWINGS

FIG. 1a is a perspective view of a standard television or monitor or similar device showing a streaming video (commercial, movie, television show, sponsored material, live or recorded, etc.) program.

FIG. 1b is a sectional view of a standard television or monitor or similar device showing a streaming video (commercial, movie, television show, sponsored material, live or recorded, etc.) program with peer-to-peer communication being conducted between two individuals and displayed on the screen.

FIG. 1c is a sectional view of a standard television or monitor or similar device showing a streaming video (commercial, movie, television show, sponsored material, live or recorded, etc.) program with peer-to-peer communication being conducted between two individuals and displayed on the screen, while also showing a company logo displayed during this communication, (The logo is representative of a matched the advertiser's assets: logo, graphic, watermark, banner, video, and the like (with or without static, 3-D, sound, picture-in-picture, etc.) from the streaming video content on the screen, found within the DAI Ad Server Library (Asset Library) using the DAI Ad Video Recognition Software while the peer-to-peer conversation is taking place.)

FIG. 2 is a representation view of a standard cable set-top box installed with the present invention software, and the DAI Ad Server Library (Asset Library), where the advertiser's assets logos, graphics, watermarks, banners, videos, and the like (with or without static, 3-D, sound, picture-in-picture, etc.) of the client are housed.

FIG. 3 is a representation view of a proprietary designed cable set-top box incorporating the present invention software and the DAI Ad Server Library (Asset Library), which is the client logo database.

FIG. 4 is a representation view of a communication means initially coming from a corporate entity to the internet which generates a signal communication means to a computer, wireless television, cell or smart phone, or similar device.

FIG. 5a is flowchart demonstrating the software logic sequence.

FIG. 5b is a continuation of the flowchart demonstrating the software logic sequence.

FIG. 6 is a more detailed description of the standard proprietary designed cable set-top box components.

### DESCRIPTION OF THE PREFERRED EMBODIMENTS

Authentication refers to the technology that ensures that a message, data, control command signal or information that is downloaded or transferred from a one person or device to another declared or intended person or device.

Encryption refers to a privacy technology that prevents anyone but the intended recipient(s) to download, review or read confidential information, signal and/or data.

Integrity refers to technology that ensures that a message, information, control command signal, and/or data do not alter in any way during transit.

Non-repudiation refers to the technology that prevents a sender from denying that a message, data, control command signal or information was sent.

Wireless and wired communication technology refers to all current and future variants, revisions and generations (e.g. third generation (3G), fourth generation (4G), fifth generation (5G) and all future generations) of Global System for Mobile Communication (GSM), General Packet Radio Service (GPSR), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA, Integrated Digital Enhance Network (iDEN), HSPA+, WiMAX, LTE, Flash-OFDM, HIPERMAN, WiFi, IBurst, UMTS, W-CDMA, HSPDA+HSUPA, UMTS-TDD and other formats for utilizing cell phone technology, telephony antenna distributions and/or any combinations thereof and including the use of satellite, microwave technology, the Internet, cell tower, telephony and/or public switched telephone network lines.

A television computer monitor, desktop or laptop, cell phone, smart phone, tablet, or similar apparatus includes all television with wired or wireless communication technology, remote cellular phones using channel access methods defined above (with cellular equipment, public switched telephone network lines, satellite, tower and mesh technology), mobile phones, PDAs, tablets (e.g. refers to all current and future variants, revisions and generations of the Apple IPAD, Samsung Galaxy, HP, Acer, Android, Microsoft, Nook, Google Nexus, Sony, Kindle and all future tablets manufactured by these and other manufactures), Apple IPOD Touch, or a television, timepiece or computerized watch, computerized glasses and other similar apparatus with WIFI and wireless capability, and remote computers and controllers having internet or wireless connectivity.

Cellular format technology refers to all current and future variants, revisions and generations (e.g. third generation (3G), fourth generation (4G), fifth generation (5G) and all future generations) of Global System for Mobile Communication (GSM), General Packet Radio Service (GPSR), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA, Integrated Digital Enhance Network (iDEN), HSPA+, WiMAX, LTE, Flash-OFDM, HIPERMAN, WiFi, IBurst, UMTS, W-CDMA, HSPDA+HSUPA, UMTS-TDD and other formats for utilizing cell phone technology, telephony antenna distributions and/or any combinations thereof, and including the use of satellite, microwave technology, the internet, cell tower, telephony and/or public switched telephone network lines.

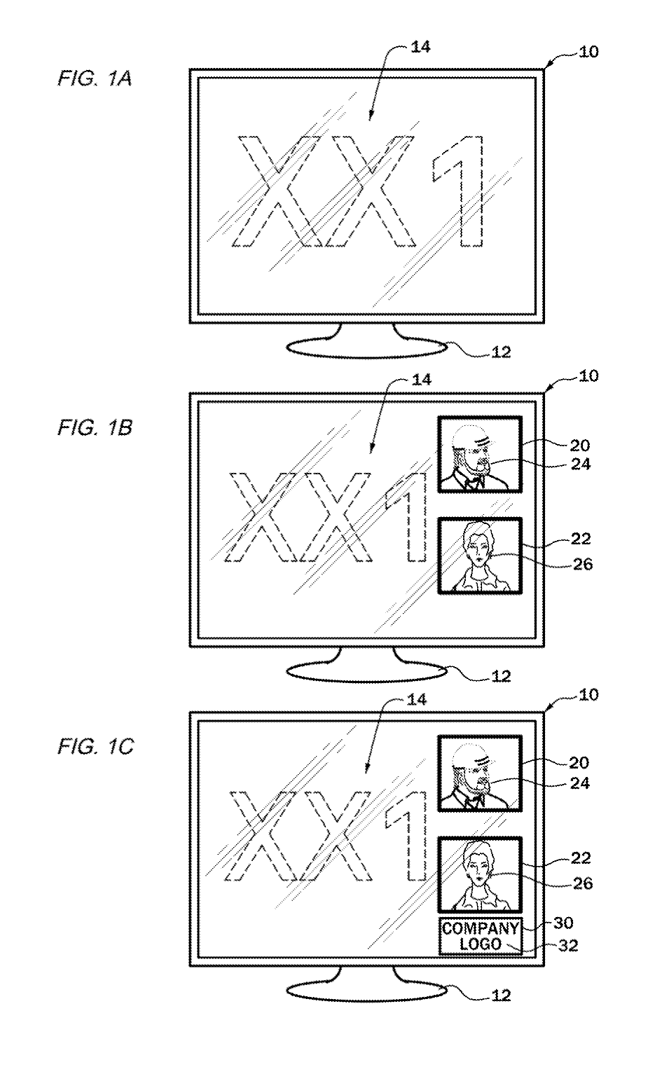

Now referring to FIG. 1a, shown is a perspective view of a standard (or smart) television or computer monitor or similar device that displays digital signals on a display screen 10 showing streaming video content (e.g., a commercial, movie, television show, sponsored material, live or recorded, etc.) 14. The streaming video content 14 comprises the transmission of dynamic or sometimes static images, generally with accompanying sound, via electric or electromagnetic signals. Also shown is a support stand that provides support at the base of a television or computer monitor or similar device.

FIG. 1b is a sectional view of a standard (or smart) television or computer monitor or similar device that displays digital signals on a display screen 10 and having a base 12. Shown on the display screen of the television, computer monitor, or similar device, the streaming video content 14 comprises the transmission of dynamic or sometimes static images, generally with accompanying sound, via electric or electromagnetic signals. Also shown is streaming video content via a commercial or television computer monitor or similar device 10 with a peer-to-peer communication 20, 22 being conducted between a caller 24 and a call recipient 26 and displayed on the television screen 10. A peer-to-peer computer network is one in which each television, computer monitor, or similar device in the network can act as a client or server for the other television, computer monitor, or similar devices in the network, allowing shared access to various resources such as voice over Internet protocol (VoIP) without the need for a central server. Sometime known as the P2P, these networks can be set up within the home, a business, and are generally conducted over the Internet. One of the best examples of VoIP peer-to-peer communication is Skype. Skype was first released in 2003 and the computer software code was written by Estonian developers Ahti, Heinla, Priit Kasesalu and Jaan Tallinn who had also originally developed Kazaa. It evolved into a platform with over 600 million users and was eventually acquired by Microsoft corporation in 2011 for $8.5 billion. The Skype service allows users to communicate with peers by voice using a microphone, video by using a webcam, and instant messaging over the Internet. Phone calls may be placed to recipients on the traditional telephone networks. Calls to other users within the Skype service are free of charge, while calls to landline telephones and mobile phones are charged via a debit-based user account system. Skype has also become popular for its additional features, including file transfer and video conferencing. Competitors include SIP and H.323-based services, such as Linphone, Google Talk, Apple Ichat, GotoMeeting, Webinars, Podcasts, and the like.

Unlike most other VoIP services, Skype is a hybrid peer-to-peer and client-server system. It makes use of background processing on computers running Skype software. Skype's original proposed name (Sky Peer-to-Peer) reflects this fact.

FIG. 1c is a sectional view of a standard television computer monitor or similar device 10 having a base 12 and showing streaming video content on the screen 14 with a peer-to-peer communication 20, 22 being conducted between a caller 24 and a call recipient 26. Displayed on the screen, represented here as a television or computer, but can also be a cell phone display, or similar device that shows the company's logo/advertiser's asset: logo, graphic, watermark, banner, video, and the like (with or without static, 3-D, sound, picture-in-picture, etc.) 32 displayed in a section 30 of the screen during the peer-to-peer communication 20, 22. Company logo or advertisement refers to the advertiser's assets: logo(s), graphic(s), watermark(s) banner(s), video(s), and the like (with or without static, 3-D, sound, picture-in-picture, etc.) that is incorporated in a strategic, non-intrusive and predetermined or designated location within or outside of the video chat foreground (depending on what setting the user has made) during a peer-to-peer conversation. This figure is shows the company logo, aka advertiser's assets: logos, graphics, watermarks, banners, videos, etc. 32 in the lower right corner of the screen; but, the Applicant anticipates that the advertiser's assets (as mentioned above) can be located in different predetermined or designated areas, corners, or other parts of television screen, computer screen, cell phone display or similar device. The company logo or advertiser's asset 32 is displayed during the peer-to-peer communication 20, 22. If the peer-to-peer communication 20, 22 end while the streaming video content is displayed on the screen, the company logo or advertisement 32 will be removed from the screen in which was playing. If the peer-to-peer communication 20, 22 continues but the streaming video content displayed on the screen ends, the advertiser's asset (company logo) 32 will remain on the screen until another streaming video content is displayed on the screen. If another vendor's streaming video content 14 is displayed, the present invention software will recognize the new or different streaming video content (commercials, movies, television shows, sponsored material, live or recorded, etc.) or programming, and associate a new logo that matches to the respective content being shown. This cycle continues until the peer-to-peer communication 20, 22 is terminated.

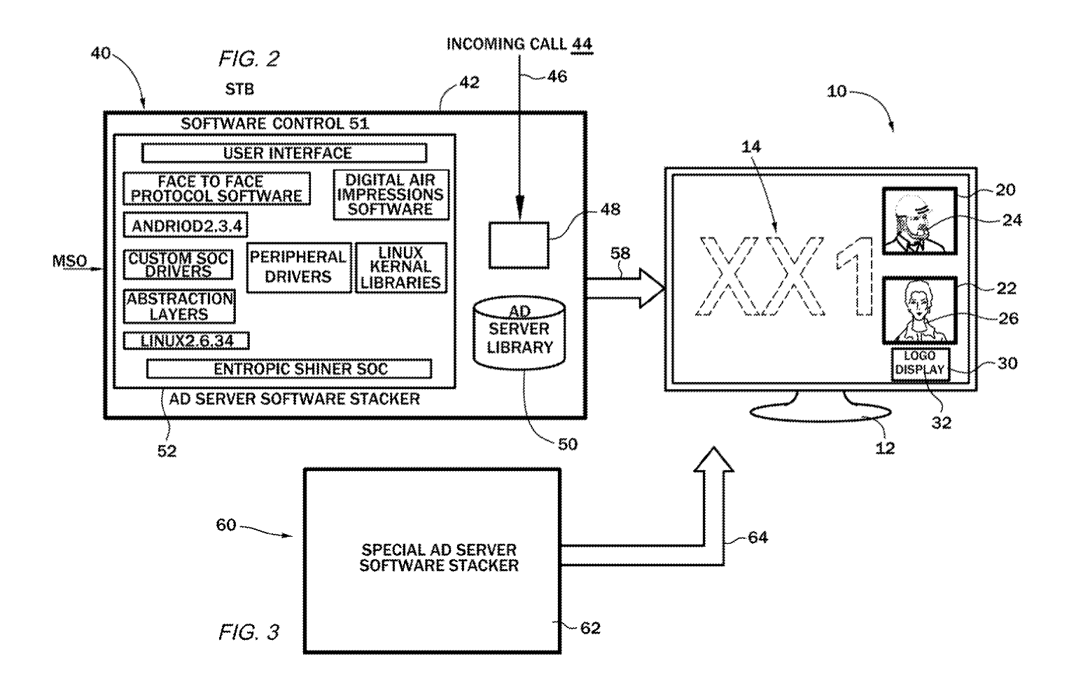

Now referring to FIG. 2, shown is a sectional view of a standard television, computer monitor, or similar device 10 having a base 12 and showing streaming video content 14 with a peer-to-peer communication 20, 22 being conducted between a caller 24 and a call recipient 26. The streaming video content 14 displayed on the screen also show a company logo/advertiser's asset 32 displayed in a section 30 of the screen during the peer-to-peer communication 20, 22. The company logo refers to the advertiser's assets: logo, graphic, watermark, banner, video, and the like (with or without static, 3-D, sound, picture-in-picture, etc.), which are incorporated in a strategic, non-intrusive and predetermined or designated location within or outside of the video chat foreground (depending on what setting the user has designated) during a peer-to-peer conversation.

Also shown is a representation view of a standard cable set-top box 40 installed with the present invention software 51 and client logos or advertising database, DAI Ad Server Library (Asset Library), 50. The present invention software as Ad Server Software Stacker 51 comprises ten components: a user interface, peer-to-peer protocol software, Digital Air Impressions Ad Video Recognition Software, an operation system (shown as Android 2.3.4), Custom system on chip (SOC) drivers, peripheral drivers, Linux kernel libraries, abstraction layers, Linux 2.5.34, entropic shiner SOC. Also shown is a PSTN phone line communication (Public Switched Telephone Network) 46. PSTN networks are the world's public circuit-switched telephone networks that are all inter-connected by switching centers, thus allowing any telephone in the world to communicate with any other. It is also anticipated that the incoming peer-to-peer call can use cellular wireless technology as defined herein. The software control 51 consists of: (1) an ID signature (Identity signature is an encrypted database for software that encodes video with a unique identifier that corresponds with the DAI Ad Server Library (Asset Library)). (2) DAI Ad Video Recognition Software that detects and identifies the signature encoded within the streaming video content of a Skype or Skype-like capable device, such as a set-top box, monitor, television, and so forth. This software recognizes when a Skype, FaceTime, Google Talk, iChat, and the like session begins while watching or viewing streaming video content on a TV, Smart phone, Tablet, the Internet, and the like. When the signature is detected on the HDMI input, DAI sends the ID signature to the set-top box, which then initiates a signal to the DAI Ad Server Library (Asset Library) to find the corresponding advertiser's asset logo, graphic, watermark, banner, video, etc., and incorporates it onto the screen. (3) DAI Ad Server Library (Asset Library) that stores the advertiser's assets: logos, banners, watermarks, graphics, video, and the like (with or without static, 3-D, sound, picture-in-picture, etc.). An input means 56, used to communicate with the standard cable set-top box 40, is a MSO (Multiple System Operators), which refers to operators of multiple cable television systems whereby the majority of system operators run cable systems in more than one community and hence most of them are multiple system operators. The client logos and advertising database, DAI Ad Server Library (Asset Library), 50 which houses the advertiser's assets: logos, graphics, watermarks, banners, videos, and the like (with or without static, 3-D, sound, picture-in-picture, etc.) of the client, includes the technology and service that places advertisements on the screen and the library is which houses this. Ad servicing technology companies provide software to advertisers to serve ads, count them, choose the ads that will make the website or advertiser the most money, and monitor progress of different advertising campaigns.

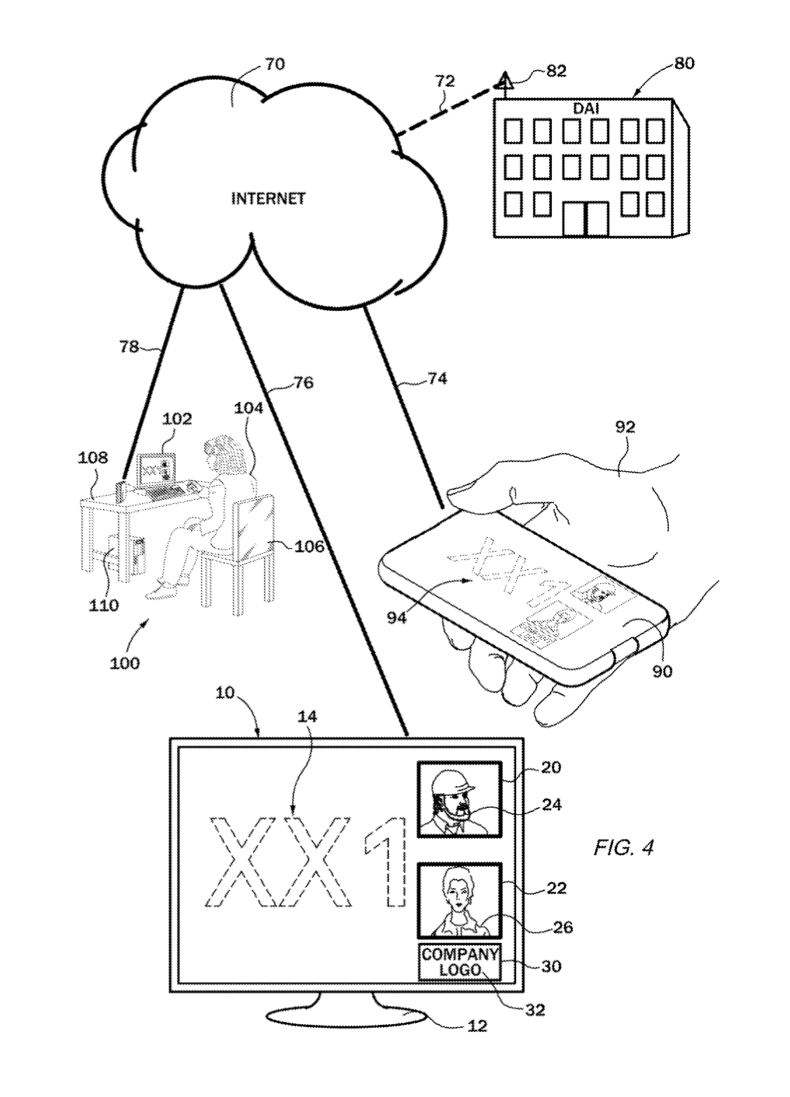

FIG. 3 is a representative view of a proprietary designed cable set-top box 60 incorporating the present invention software, Ad Server Software Stacker, 62 and the client logo/advertiser's assets database, which is the DAI Ad Server Library (Asset Library), 50. As applicable to the modified standard cable set-top box 40, a PSTN phone line communication (Public Switched Telephone Network) 46 can be incorporated into the proprietary designed cable set-top box 60. PSTN networks are the world's public circuit-switched telephone networks that are all inter-connected by switching centers, thus allowing any telephone in the world to communicate with any other. It is anticipated that the proprietary designed cable set-top box, the Ad Server Software Stacker, 60 can send display signals for incoming peer-to-peer calls that use cellular wireless technology as defined herein. The software control is analogous to the software 51 described in the prior embodiment and consists of (1) an ID signature (Identity signature is an encrypted database for software that encodes video with a unique identifier that corresponds with the DAI Ad Server Library (Asset Library)), (2) DAI Ad Video Recognition Software, detection software that identifies the signature encoded in the streaming video content (e.g., commercial, movie, television show, sponsored material, live or recorded, etc.) of a Skype-type capable device, such as a set-top box, monitor, television, and so forth. This software recognizes when a Skype, FaceTime, Google Talk, iChat, and the like session begins while watching or viewing streaming video content on the TV, Internet, Tablets, Smart phones, and the like. When the signature is detected on the HDMI input, DAI sends the ID signature to the set-top box, which then initiates a signal to the DAI Ad Server Library (Asset Library) to find the corresponding advertiser's asset: logo, graphic, watermark, banner, video, etc., and incorporates it onto the screen. (3) And an Ad Server Library (Asset Library) that stores the advertiser's assets: logos, banners, watermarks, graphics, videos, and the like (with or without static, 3-D, sound, picture-in-picture, etc.). This proprietary designed cable set-top box 60 also has an input means analogous to 56 that consists of a MSO (Multiple System Operators) which refers to operators of multiple cable television systems whereby the majority of system operators run cable systems in more than one community and hence most of them are multiple system operators. The client logos/advertiser's assets in the DAI Ad. Server Library (Asset Library) 50 includes the technology and service that incorporates logos, graphics, watermarks, banners, videos, and the like (with or without static, 3-D, sound, picture-in-picture, etc.) on the screen and the library which houses this. Ad servicing technology companies provide software to advertisers to serve ads, count them, choose the ads that will make the website or advertiser the most money, and monitor progress of different advertising campaigns.

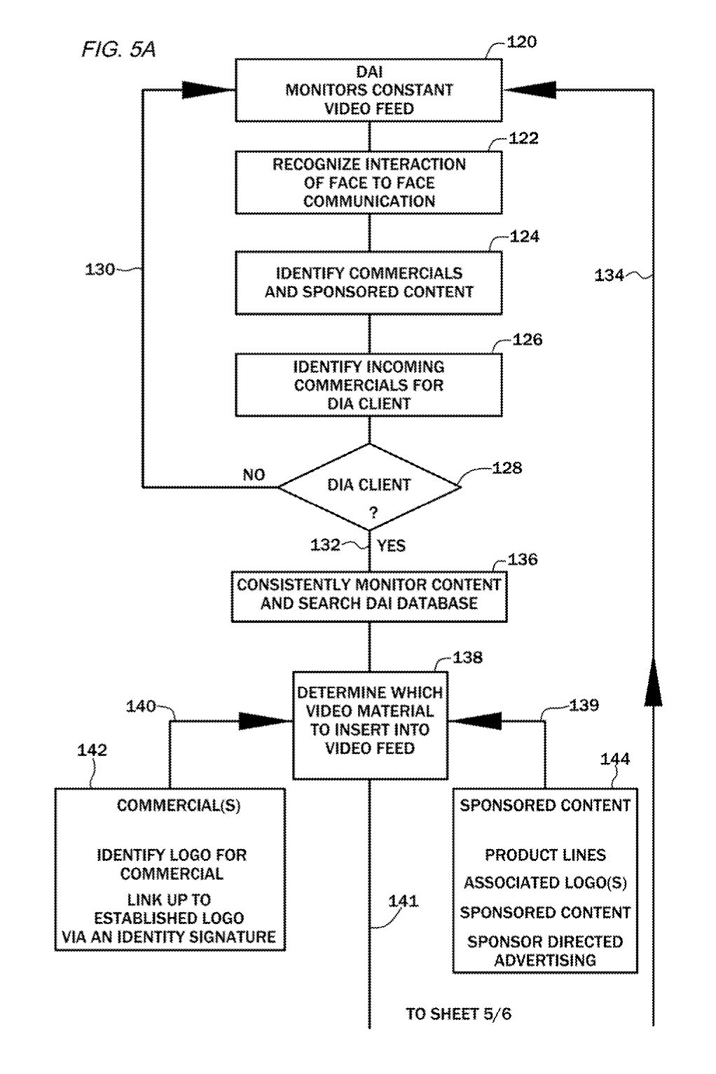

FIG. 4 is a representation view of a communication means 72 generated from an antenna means 82 coming from a corporate entity 80 to the internet 70 which generates a signal with a communication means 78 to a computer station 100, a signal with communication means 76 to a television (wireless or non) or a monitor 10, and/or a signal with communication means 74 cell or smart phone or similar device 90. The internet generated signal with a communication means 78 that communicates with the computer station 100 that generally delivers Internet connectivity via a modem/server system 108 that is either wired with an Ethernet system or wireless transferred to the computer 110. As shown, an operator or individual 104 is sitting on a chair 106 and viewing a computer display means 102 that is showing streaming video content 14 with a peer-to-peer communication 20, 22 being conducted between a caller 24 and a call recipient 26. Displayed on the computer screen display 102 is also showing a company logo or advertiser's assets 32 displayed in a section 30 of the computer screen during the peer-to-peer communication 20, 22.

The internet generated signal with communication means 76 to a wireless television 10 has a base 12 and streaming video content 14 with a peer-to-peer communication. 20, 22 being conducted between a caller 24 and a call recipient 26 similar to that graphical depicted in FIG. 1c. The streaming video content 14 displayed in FIG. 1c on the wireless television screen is the advertiser's asset: the company's logo, graphic, watermark, banner, video, and the like with or without static, 3-D, sound, picture-in-picture, etc.) 32 displayed in a section 30 of the computer screen during the peer-to-peer communication 20, 22.

The internet generated signal with communication means 74 to a smart phone or similar device 90 with a display screen 94 and showing streaming video content 14 with peer-to-peer communication 20, 22 being conducted between a caller 24 and a call recipient 26. Shown on the display of a cellular, smart phone display, tablet, or similar device display 94 also showing the advertiser's assets (from the DAI software) 32 displayed in a section 30 of the display screen 94 during the peer-to-peer communication 20, 22.

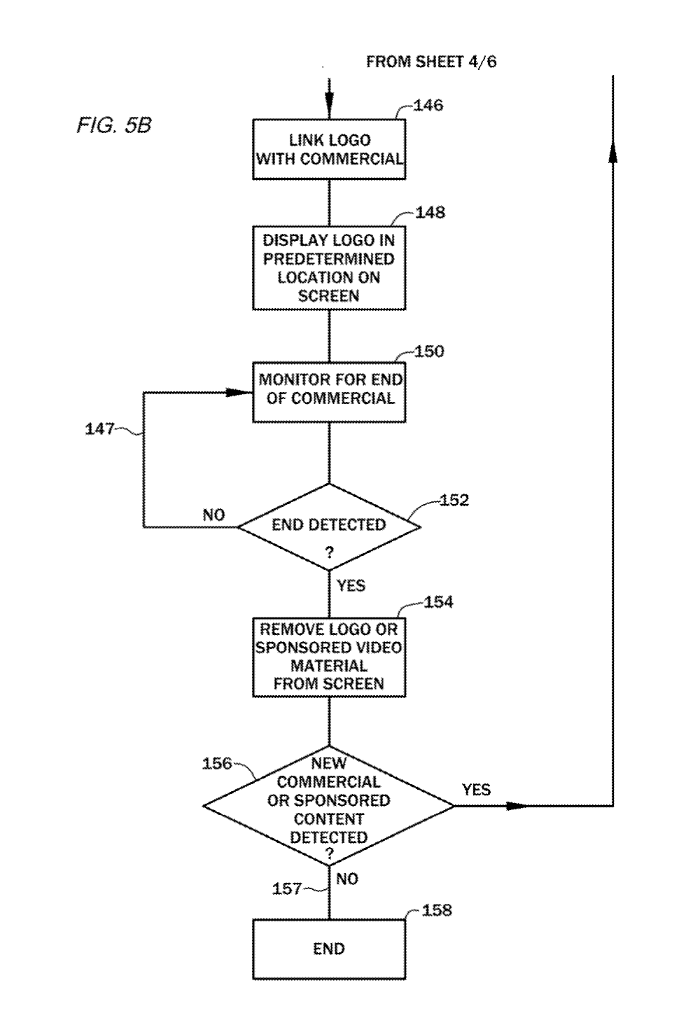

FIG. 5a is flowchart demonstrating the software logic sequence that is used in either the standard set-top box 40 including the ad server software stacker 51 or proprietary designed cable set-top box 60 with the ad server software stacker 51. The flowchart shows that the ad server software stacker 51 constantly monitors the video feed 120. When a peer-to-peer communication is recognized 122, the software proceeds to identify commercials and sponsored content 124. The identification process continues as the software 51 determines if the streaming video content is a DAI registered paying client 126. If it determined that the streaming video content is not a registered paying client, the software 51 logic loops back to monitoring the video feed 130. If it is determined that the streaming video content is a registered paying client, then the software 51 proceeds to step 136 where the software 51 monitors consistently monitors streaming video content and searches the database. The software 51 then determines what video material to insert into the video feed 138. If the software 51 recognizes streaming video content, a commercial here for example, it then identifies the particular advertiser's asset to link-up to the commercial (via an identity signature) 142. If the software 51 recognizes sponsor content, then it identifies the product lines and feeds the associated logo, sponsored content, or sponsor directed advertising 144.

FIG. 5b is a continuation of the flowchart demonstrating the software logic sequence. The software 51 continues along the sequence 141 and links the appropriate advertiser's asset: logo, graphic, watermark, banner, video, and the like (with or without static, 3-D, sound, picture-in-picture, etc.) to the streaming video content (commercial, movie, television show, sponsored material, live or recorded, etc.) 146. The software displays the logo in a strategic, nonintrusive and predetermined or designated location of the canvas the computer, television, smart phone, or similar device screen 148. The software 51 monitors for the end of the streaming video content (e.g., commercial, movie, television show, sponsored content, live or recorded, etc.) 150 and if or streaming video content has not ended and is continuing, then the software 51 logic loops back 147. When the streaming video content (commercial, movie, television show, sponsored content, live or recorded, etc.) has ended and the end is detected 152 by the software 51, then the sequence continues to step 154 where the software 51 removes the advertiser's asset: logo, graphic, watermark, banner, video, etc. from the computer, television, or smart phone or similar device screen. The software 51 continues to monitor during the peer-to-peer call and if new streaming video content is detected 156, the software 51 loops back to step 120 (shown of FIG. 5a). If no new streaming video content is detected 157 or the peer-to-peer communication ends 158, the entire software sequence ends.

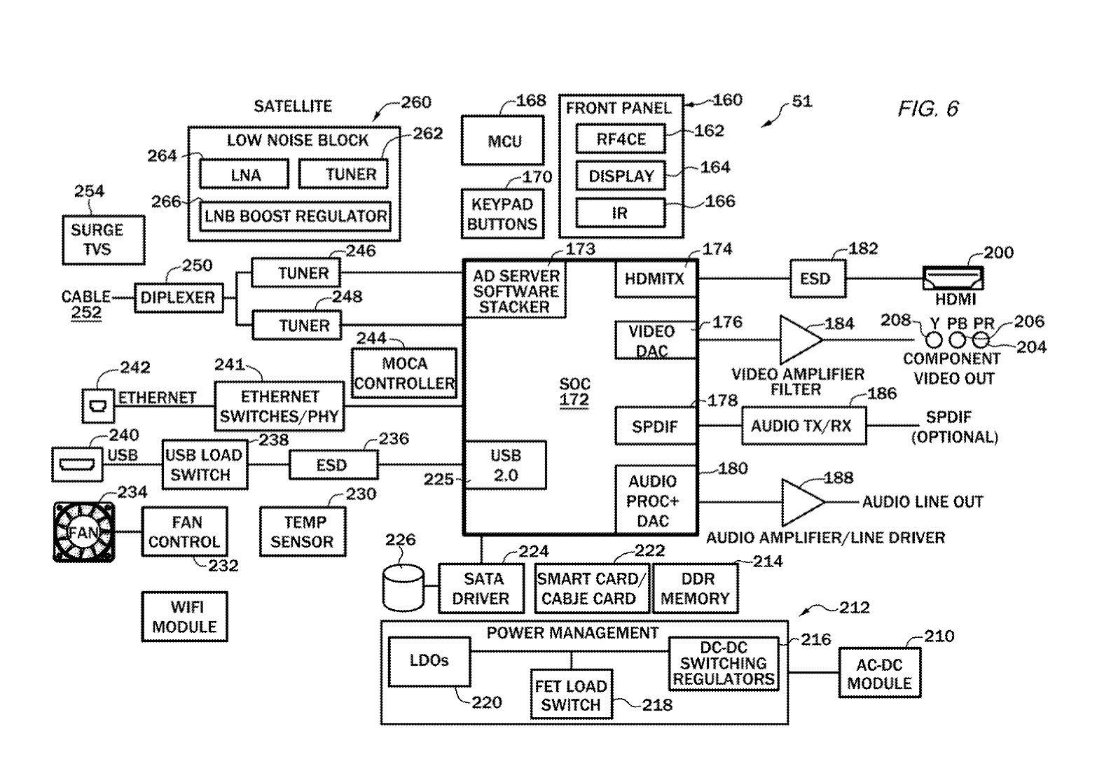

Now referred to FIG. 6 which provide a more detailed description of the standard proprietary designed cable set-top box components. There are several components that either are directly or indirectly necessary to carry out the method of the present invention.

The Digital Air Impressions Ad Recognition Software and System 51 Consisting of (1) an ID signature (Identity signature is an encrypted database for software that encodes video with a unique identifier that corresponds with the DAI Ad Server Library). (2) Detection software that identifies the signature encoded in the video content of a Skype-type capable device, such as a set-top box, monitor, television, and so forth. This software recognizes when a Skype, FaceTime, Google Talk, iChat, and the like session begins while watching or viewing video content on the TV, Internet, Tablets, Smart Phones, and the like. When the signature is detected on the HDMI input, DAI sends the ID signature to the set-top box, which then initiates a signal to the DAI Ad Server Library to find the corresponding overlay (logo, etc.) and places it onto the screen. (3) And an Ad Server Library that stores the logos/banners/graphics and/or video/audio (with or without static, 3-d, sound, etc.).

Shown on FIG. 6 is a front panel that is part of the set-top box that usually faces the user. The RF4CE 162, Display 164, and IR 166 are included in it. The RF4CE 162 solution enables design of advanced remote control devices for more intuitive and enjoyable remote control user experiences. Such as delivering remote controls with mouse-like pointing and keyboard functionality, as well as gesture and touch-based input controls. Display 164 part of the set-top box that lights up with numbers and/or letters in a designed graphical format and typically faces the user. Infrared signal 166 has two emitters (also called “IR blasters”) at one end, is used to send signals from the DVR to your cable or satellite box or digital adapter (DTA). These signals allow the DVR to change the channels on any of these set top boxes.

The MCU (Micro Controller Unit) 168 also known as a microcontroller, it is a single chip that contains the processor (CPU), non-volatile memory for the program (ROM or flash), volatile memory for input and output (RAM), a clock and an I/O control unit. The microcontroller can be used for managing the interface with the remote control and other user interface peripherals.

The Keypad buttons 170 consists of a device with a set of buttons arranged in a block or “pad” which usually bear digits, symbols and usually a complete set of alphabetical letters.

SoC (System on Chip) 172 included inside are: Ad Server Software Stacker, HDMITX, Video DAC, SPDIF, AudioProac+DAC, and USB 2.0. The SoC sets new standards of performance, security, and integration while retaining backward compatibility. It supports higher RGB16 graphics specification and the chip's integrated ST20 CPU operates at speeds up to 180 MHz. Audio options include MP3 decoding, Dolby Digital and Pro Logic decoding; support is also provided for SRS TruSurround virtual surround sound. The IC (integrated circuit) also integrates a multi-channel DMA engine, making it suitable for use in graphic applications, such as DVB-MHP, browser-based middle wares, and IPTV. Other features of the SoC include a 16-bit, 133-MHz shared-memory interface with support for 64- and 128-bit configurations, an external memory interface supporting six configurable banks of SRAM, flash and DRAM, a MPEG-2 decoder, and a graphics/display unit with five display planes.

Ad Server Software Stacker 173, which is contained inside the SoC 172 consists of 10 components: (1) User Interface (UI), which includes connectivity to the remote control via an IrDA or low-power wireless device residing in the unit itself as well as on the remote control unit; most STBs now utilizes an RF (radio frequency) remote control using RF4CE (2) Face-to-Face Protocol Software; (3) Digital Air Impressions Software; (4) Android 2.3.4; (5) Custom SoC Drivers; (6) Peripheral Drivers; (7) Linux Kernal Libraries, (8) Abstraction Layers; (9) Linux 2.6.34; and (10) Entropic's Shiner SoC.

The HDMI TX (transmitter) 174 which is also contained within the SoC 172, provides the necessary logic to implement and verify designs for various consumer electronic applications, which includes a suite of configurable digital controllers and high-speed, mixed-signal PHI IP (allowing designers to integrate a Hi-Speed USB 2.0 host or devise into set-top boxes and consumer electronics). This functions extremely low in power and area. It is comprised of three line drivers for data transmission and an additional line driver for clock transmission. It is designed to perform the serialization and transmission of video data and control information through an HDMI interface; the HDMI TX 174 hard-macro interfaces with the HDMI Link Controller through a common graphic controller interface, supporting up to 30 bit data transfer with data enable, while the clock line driver is used for reference clock transmission. It is targeted for digital video/audio transmission for high-resolution display applications, supporting major display formats up to 3D formats, 4K×2K resolution and 1080i/p in DTV applications and QXGA in graphic display applications, with True-color or Deep-color resolutions. At maximum pixel rate, the HDMI channel bit rate is 3.4 Gbps, allowing a maximum effective throughput of 8.16 Gbps.

The Video DAC 176 also contained with the SoC 172, includes a small amount of logic inside the video current. Data enters the Video DAC 176 on the input data signals and then is latched using the rising edge of the clock signal. Once the data is latched, it is then routed to a decode logic circuit, whose function is to convert the DAC data into individual signals that will drive the DAC current source switches in the output stages of the D/As. For a 10-bit DAC, this would mean decoding the 10 bits into 1024 individual signals. These individual signals are in turn, routed to a second set of latches. These latches are sometimes referred to as “local” latches since each latch is located near its corresponding set of switches in the output stage of the DAC.

The SPDIF (Sony/Philips Digital Interconnect Format) 178, located within the SoC 172, is an audio SPDIF input/output interface requiring a digital audio transceiver that is a type of digital audio interconnect cable used in consumer audio equipment to output audio over reasonably short distances.

The AudioPROC+DAC 180, also contained within the SoC 172. The AudioProc is a high-quality, expert-level audio dynamics processor for Winamp that utilizes the same multiband compression/expansion limiting technology that expensive professional broadcast hardware is based upon. Music is enhanced to provide more loudness, punch and consistency in volume and spectral balance. Dull or quiet material will be livened up, and excessively edgy or loud material will be softened and tamed. The result is a warm and bright, non-fatiguing, properly balanced and artifact-free sound that resembles the competitive “on the air” sound signature of major market FM radio stations and fully configurable. A digital-to-analog converter (DAC) is a semiconductor device that is used to convert a digital code (usually binary) into an analog signal, such as electric charge, current, or voltage. A DAC is the principal means by which computer and digitally-based systems translate digital data into real-world signals. An audio-quality DAC has specifications tuned for audio applications such as a high dynamic range with low to no distortion (I.e., it can supply amplification for reproduction of audio and/or video signals through speakers or television)

Also shown in FIG. 6 is an ESD (Electrostatic discharge) 182 HDMI/DVI interface. Since USB is a hot insertion and removal system, USB components are subject to Electrostatic Discharge (ESD). However, USB ESD protection is not yet a specific requirement of the USB specification. State-of-the-art USB ICs are manufactured on high integration CMOS processes making them extremely sensitive to damage from the high static voltages associated with an ESD event. A Video Amplifier/Filter 184 consists of a video output amp. The video interfaces (output) include HDMI and Component and/or Composite video. These outputs often require high-performance video filters/amplifiers to enhance the video output from the SoC (System on Chip). Additionally these outputs often require ESD protection. Newer STB platforms provide RD (High. Definition) as well as full RD at 1080p resolution and 3D.

Audio TX/RX 186 is an optional digital audio transceiver with analog conversion capabilities. The digital audio transceiver (TX/RX) is used for audio products are a subset of analog Analog & Mixed-Signal solutions.

The Audio Amplifier/Line Driver (Audio Line Out) 188 takes audio output from the SoC (System on Chip) is made available via the stereo output jack and headphones. With such features as high SNR (Signal-to-Noise Ratio) and analog low-pass filtering, a high-quality audio output is required as well as an audio line driver. Additionally there may be an audio SPDIF (Sony/Philips Digital Interconnect Format) input/output interface requiring a digital audio transceiver.

HDMI 200 refers to a high definition multimedia interface. Component Video Output 202 is a video signal split into two or more component channels. The video interfaces (output) include HDMI and Component and/or Composite video. These outputs often require high performance video filters/amplifiers 184 to enhance the video output from the SoC (System on Chip). Additionally, these outputs often require ESD protection. Newer STB platforms provide HD (High Definition) as well as full ED at 1080p resolution and 3D. YPbPr is a color space used in video electronics, in particular in reference to component video cables. YPbPr is the analog version of the YCbCr color space; the two are numerically equivalent, but YPbPr is designed for use in analog systems whereas YCbCr is intended for digital video. YPbPr is converted from the RGB video signal, which is split into three components: Y, PB, and PR. PR 204 is the analog video signal carried by component video cable in consumer electronics. PR carries the difference between red and luma (R−Y). In consumer electronics, PR is the red cable. PB 206 carries the difference between blue and luma (B−Y). In consumer electronics, PB is the blue component video cable. Y 208 carries luma (brightness or luminance) and synchronization of information. Y=0.2126 R+0.7152 G+0.0722 B. Before the advent of color television, the Y axis on an oscilloscope display of a video waveform represented the intensity of the scan line. With color, Y still represents intensity but it is a composite of the component colors. In consumer electronics, Y is the green component video cable.

The AC-DC Module 210 is a Digital Audio Interface with audio output from the SoC (System on Chip) is made available via the stereo output jack and headphones. With such features as high SNR (Signal-to-Noise Ratio) and analog low-pass filtering, a high-quality audio output is required as well as an audio line driver. Additionally there may be an audio SPDIF (Sony/Philips Digital Interconnect Format) input/output interface requiring a digital audio transceiver.

Power management 212 includes LDOs, a FET Load Switch, and DC-DC Switching Regulators. The AC-to-DC conversion (adjacent to power management) creates the main power for the unit itself, the functional blocks in the STB that require powering. The power architecture for the STB will vary by platform depending upon the core SoC (System on Chip), memory, analog front-end, analog signal chain components and interfaces used in the specific platform. High efficiency single and multi-output switching regulators and low current LDOs are required, MOSFET load switches can be used for sequencing of the power rails. TI offers all the necessary power solutions to meet stringent energy conservation mandates.

DC-DC Switching Regulators 216, associated with the power management 212, is a voltage regulator that uses a switching element to transform the supply into an alternating current, which is then converted to a different voltage using capacitors, inductors, and other elements, then converted back to DC.

FET Load Switch 15, also associated with the power management 212 above) is a field-effect transistor (FET) load switches can be used for sequencing of the power rails. The field-effect transistor operates in depletion mode within a circuit. The channel between the source and drain junctions is normally open, with the current meeting no resistance as it travels over the channel. As voltage is applied to the gate junction, it affects the resistance that the current encounters across the channel, increasing or decreasing it. The result is a variable resistor that can be controlled within the circuit by varying the voltage to the gate.

220 LDOs 220, also inside Power Management 212 above, is linear regulators and low dropout regulators (LDOs) feature low quiescent current that increases efficiency in a variety of applications. LDOs are a simple, inexpensive way to regulate an output voltage powered from a higher voltage input.

DDR Memory 214 is a Double Data Rate Memory is used for memory chips. Also, a Set-Top Box is comprised by modules that access an external memory sharing the same bus. Thus, it is necessary for a multichannel DDR memory controller to schedule accesses.

The Smart Card/Cable Card 222 contains the customer's account information as well as the channel assignments and decryption algorithms used by the cable provider.

The SATA Driver 224 Serial Advanced Technology Attachment, often abbreviated SATA or S-ATA, is a serial link—a single cable with a minimum of four wires creating a point-to-point connection between devices.

USB 2.0 225, located inside the SoC 172, is sometimes referred to as Hi-Speed USB, this is a new standard (from the previous, slower transfer speeds of USB 1.1) that supports data rates of up to 480 Mbps. The USB 2.0 is designed to be fully compatible with earlier versions of USB (e.g. 1.1).

226 is an optional hard drive to contain information that can be downloaded remotely to update features of the present invention.

Having an WI-FI Module 228 inside of the set-top box allows the connection to the home WI-FI network for internet access and for streaming audio to transmit and receive.

A Temp Sensor 230 can be incorporated into the present invention that controls the temperature within the set-top box so it does not exceed a certain point as to overheat. Fan Control 232 controls the fan to turn on when the temperature reaches a certain set point so it can regulate itself. Pan 234 is a thermal management strategy that includes actively removing heat from the enclosure with one or more fans.

ESD (Electronic Software Distribution) 236 is a hot insertion and removal system for USB components that are subject to Electrostatic Discharge (ESD). However, USB ESD protection is not yet a specific requirement of the USB specification. State-of-the-art USB ICs are manufactured on high integration CMOS processes making them extremely sensitive to damage from the high static voltages associated with an ESD event.

USB Load Switch 238 is designed for high-side power switching applications to cover a wide range of port protection applications, such as USB. Port protection switches provide inrush current limiting, short-circuit and over-temperature protection, in addition to input control level shifting and fault flags.

USB (Universal Serial Bus) 240 is an external bus port that can support data transfer of up to 12 Mbps. USB ports can be used to connect various peripherals including mice, keyboards, external hard drives, cameras, modems, etc. A USB input to the STB requires current-limit ESD (electrostatic discharge) protection.

The Ethernet 242 represents the global standard for cabling computers together in a network. Almost every reference to “network,” “network ready,” “LAN,” “LAN connection” or “network card” implies Ethernet. One or more Ethernet inputs may be present for providing media content over the Ethernet. Ethernet Switches/PHY 243, is an Ethernet network that is controlled by a switch instead of a shared hub. The switch cross connects all clients, servers and network devices, giving each sending-receiving pair the full rated transmission speed.

MoCA Controller 244, known as the Multimedia over Coax Alliance, is a standards organization that supports a technology to provide the backbone for home digital entertainment networks. For the end-consumer, a MoCA solution includes a set-top box solution that works where your TV works, and enables you to link entertainment devices in multiple rooms using existing wiring. MCA supports streaming media, including audio, SDTV and HDTV and provides a clean dedicated shielded medium. It coexists with CATV and terrestrial services and also supports content protection.

Tuner 246 is used as the second Diplexer is attached via coaxial cable to the back of a dual-tuner receiver.

MoCA RF (Multimedia over Coax Alliance) 248 utilizes 1.0-2.0 standard uses RP (radio frequency) signals with an operating frequency range of 500 to 1650 MHz.

The Diplexer 250 provides the chief advantage in that it allows two different devices to share a common communications channel; typically the shared channel is a long piece of coaxial cable. Rather than run two separate cables, a single cable with diplexers at each end is used. It joins, for example, a satellite dish feed and a TV antenna together into a single coaxial cable, and at a convenient point, a second diplexer would split the two signals apart; one signal would go to the TV set and the other to the set-top box.

Cable 252 refers to the standard cable system that provides content to televisions and internet service to computers and the like. Surge TVS 254 is a surge protector for the STB to protect the electrical circuitry from damage.

The Low Noise Block 258 includes a LNA, Tuner, and LNB Boost Regulator. A low-noise block (LNB) control device is capable of controlling modulation of an alternating waveform on a direct current (DC) voltage from a DC power supply to an LNB amplifier. The LNB control device includes a power supply control module, an LNB signaling module and a switch. In response to a power supply feedback signal received from the DC power supply, the power supply control module sends a control signal to the DC power supply. In addition, the LNB signaling module provides a switch control signal and a modulating waveform to the switch. Under the control of switch control signal, the switch selectively sends the modulating waveform to a summing circuit that is located external to the LNB control device. Within the summing circuit, the modulating waveform is added to the DC voltage from the DC power supply. The job of the LNB is to take a wide block (or band) of relatively high frequencies, amplify and convert them to similar signals carried at a much lower frequency (i.e., intermediate frequency or IF). These lower frequencies travel through cables with much less attenuation of the signal, so there is much more signal left on the satellite receiver end of the cable. An important performance parameter of the LNB is its noise factor; the lower the noise factor, the better the picture quality.

The Satellite connectivity 260 refers to an active antenna to get the signals needed and by using low noise engineering techniques, the sound and picture of satellite TV are higher quality. The signals received by the dish antenna are transferred to a frequency converter called the LNC (Low Noise Converter-aka LNB, low noise block), which is placed in the focal point of the dish antenna.

The Tuner 262 located within the Low Noise Block 258 provides selection of signals that come in to the satellite tuner via the LNB. Usually before the signal is sent to the tuner, the LNB needs to convert the incoming signal to a lower frequency in the area between 950 and 2150 MHz, and then amplify the signal. For good reception and image results, the quality of the LNB and the satellite tuner are of vital importance. Normal TV tuners can only handle signals between 47 to 870 MHz, whereas satellite transmission takes place between 950 and 2150 MHz. TV sets cannot generate specific LNB control signals, nor handle polarization switching. Furthermore, TV tuners cannot process the audio signals from the satellite. Some TV sets and VCRs have satellite tuners built.

The LNA 264 located inside the Low Noise Block 258, is a low noise amplifier, which is a special type of electronic amplifier or amplify weak signals captured by an antenna or satellite. The LNB Boost Regulator 266, also located within the Low Noise Block 258 boost the signal and provides a clean and quiet power source that will not contaminate the low noise RF (radio frequency) signal down converted to the receiver.

The following is a description of the Operational features of the present invention.

The system starts with off-line media processing. Normal MPEG2 or other content is post-processed to embed DAI enabling content identifying “metadata” packets and in-line graphics images. Next, when the content is played, this DAI enabled content is streamed to the set-top box. Within the STB the DAI client engine detects the embedded graphic images that are recovered and saved in the DAI Ad server Library. Finally, when the STB is in Peer-to-Peer communication mode, the embedded content ID metadata packets “arm” the DAI client engine. When the streaming video content is placed in the background by the Peer-to-Peer communication, the Client's logo, graphic, watermark, banner, video, and the like (with or without static, 3-D, sound, picture-in-picture, etc.) is incorporated in a strategic, non-intrusive and pre-determined or designated location on the screen, also known as the background canvas.

The end-to-end system is depicted in the following figure showing content pre-processing, streaming, and client elements: (see off-line diagram)

The DAI System
Supports standard definition and HD content
Integrates a Content Management and Ingest station with audit trace history
Is integrated with STB as a DAI Client Engine SDK.
Is extensible for future audio support
Is adaptable to localization and internationalization

This following section describes the main functional subsystems and their interfaces:

Content Management System

This database driven system stores catalogs raw MPEG2 files, pop-up graphics assets (bitmaps, JPEGs, etc), and DAI-enabled files. Contents are related by identifiers, for example graphics content is associated with one or more MPEG2 spot clips by Spot ID.

Content Ingest Station

This is primarily a workflow oriented system that processes incoming MPEG2 media and inserts graphics and DAI metadata packets into the MPEG2 transport files. Job Information (such as ingest state pending and completed, content asset inventory updates) is exchanged with the Content Manager. DAI enabled output files are saved and available for play to air.

Streaming Server

A stream-to-air server inputs the DAI enabled MPEG2 content and transmits to DAT enabled STB, etc. Streamed content includes MPEG2 video and audio packets, DAI metadata packets, and graphics image packets. The DAI system should require no changes to established video system infrastructure.

DAI (Client Engine) Ad Server Software Stacker

The DAI (client engine) Ad Server Software Stacker is integrated in the set-top box. It monitors active MPEG2 streams to detect the presence of DAI graphics and content ID packets. Embedded DAI packets are called back to the client engine. During normal viewing, graphics and the like are suppressed; but during Peer-to-Peer communication, the DAI software searches stored images for a match with DAI's Clients. Their advertiser assets could be logos, graphics, watermarks, banners, videos, and the like (with or without static, 3-D, sound, picture-in-picture, etc.). When an image is matched, it is, incorporated in a strategic, non-intrusive and pre-determined or designated location over the streaming video content. As the “Peer-to-Peer” is resumed to its normal function, the graphic image disappears.

In Peer-to-Peer mode, the logo, graphic, watermark, etc. must be available in its entirety so it can be rendered and incorporated over the streaming video content. Images are then transmitted together with the client's streaming video content by multiplexing in the MPEG 2 transport stream. When the content is received and recognized by the set-top box it can be saved, as an example, locally in the STB RAM as a JPEG or similar file, so that streaming video content can be matched to an available graphic file within the DAI Ad Server Library/Asset Library.

Graphic content will include an expiration date so that it can be automatically deleted in the future; the client engine will delete a graphic image when it reaches its said expiration date. For housekeeping purposes, the client engine can receive content metadata packets with control codes. This can be used to delete graphics files on demand to prevent it from accidently resurfacing.

The client engine software will need to be field upgradable for bug repairs and feature enhancements. This can be bundled into the system operators STB software refresh cycle.

Advanced Features

The content may be saved in the archive for weeks at a time before it is deleted. By managing the Clients advertiser's assets: logos, graphics, watermarks, banners, videos, and the like (with or without static, 3-D, sound, picture-in-picture, etc.) as separate files, DAI is quickly able to revise or update the Clients advertiser's assets as needed.

For example, a streaming video content clip could have a refreshed graphic downloaded each day, week, or month at a time. By referencing existing streaming video content, the new advertiser's asset: logo, graphic, watermark, banner, video, and the like (with or without static, 3-D, sound, picture-in-picture, etc.) can be repurposed seamlessly over existing content for whatever end goal the Client has in mind at that time. The possibility of a graphics carousel can also be considered so a graphic rotation could be applied to a DAI enabled spot. Further creative uses of the advertiser's assets could include sweepstakes entries, coupons, and so forth.

Push Vs. Pull Model

The general DAI concept as described is content-push, from server to STB. With a TCP/IP capable STB, it is possible the DAI client engine can also implement “out-of-band” pull features to download graphic images, software patches, report skipped spots, and so on.

Though the DAI concept is currently oriented to static logos, graphics, watermarks, banners, videos, and the like, it is soon anticipated that extensions will also be with 3-D, sound, picture-in-picture, flash, or other motion graphic, along with audio tracks integrated, into a future DAI audio subsystem.

The DAI Ad Server Software Stacker (client engine) will be designed as a Software Development Kit (SDK) and can be licensed commercially for integration into various client STB systems.

What is claimed:

1. An apparatus that is incorporated into or communicates with a standard set-top box comprising of:
a module consisting of a specialized video recognition software;
a database contains a client logo, advertising, or media content; database
said specialized video recognition software module designed to recognize and interface with streaming video content displayed on a screen of a television, computer monitor, or similar apparatus;
upon the recognition of a particular streaming video content, a server library is searched for a specific Client's advertising asset which can consist of a logo, graphic, watermark, banner, video, and the like (with or without static, 3-D, sound, picture-in-picture, etc.) and then incorporated into the foreground of the streaming video content during a peer-to-peer communication.

2. The apparatus as recited in claim 1, wherein the specialized video recognition software can embed “hooks” on to the streaming video content to activate the advertiser's assets: logo, graphic, watermark, banner, video, and the like (with or without static, 3-D, sound, picture-in-picture, etc.) during the peer-to-peer video chat screen; it is then placed within a strategic, nonintrusive and predetermined or designated location in the foreground.

3. An apparatus as recited in claim 1, wherein the unique Server Library can periodically update the advertiser's assets of the client: logos, graphics, watermarks, banners, videos, and the like (with or without static, 3-D, sound, picture-in-picture, etc.).

4. An apparatus as recited in claim 1, wherein the advertiser's assets can be display on a television screen when a peer-to-peer communication of being conducted.

5. An apparatus as recited in claim 1, wherein the advertiser's assets can be display on a cell phone screen when a peer-to-peer communication of being conducted.

6. An apparatus as recited in claim 1, wherein the advertiser's assets can be display on computer tablet screen when a peer-to-peer communication of being conducted.

7. An apparatus as recited in claim 1, wherein the advertiser's assets can be display on computerized watch screen when a peer-to-peer communication of being conducted.

8. An apparatus as recited in claim 1, wherein the advertiser's assets can be display on computerized glasses when a peer-to-peer communication of being conducted.

9. An apparatus consisting of a unique set-top box comprising of:
a module consisting of a specialized video recognition software;
a database contains a client logo, advertising, or media content; database
said specialized video recognition software module designed to recognize and interface with streaming video content displayed on a screen of a television, computer monitor, or similar apparatus;
upon the recognition of a particular streaming video content, a server library is searched for a specific Client's advertising asset which can consist of a logo, graphic, watermark, banner, video, and the like (with or without static, 3-D, sound, picture-in-picture, etc.) and then incorporated into the foreground of the streaming video content during a peer-to-peer communication.

10. The apparatus as recited in claim 9, wherein the specialized video recognition software can embed “hooks” on to the streaming video content to activate the advertiser's assets: logo, graphic, watermark, banner video, and the like (with or without static, 3-D, sound, picture-in-picture, etc.) during the peer-to-peer video chat screen; it is then placed within a strategic, nonintrusive and predetermined or designated location the foreground.

11. An apparatus as recited in claim 9, wherein the unique Server Library can periodically update the advertiser's assets of the client: logos, graphics, watermarks, banners, videos, and the like (with or without static, 3-D, sound, picture-in-picture, etc.).

12. An apparatus as recited in claim 9, wherein the advertiser's assets can be display on a television screen when a peer-to-peer communication of being conducted.

13. An apparatus as recited in claim 9, wherein the advertiser's assets can be display on a cell phone screen when a peer-to-peer communication of being conducted.

14. An apparatus as recited in claim 9, wherein the advertiser's assets can be display on computer tablet screen when a peer-to-peer communication of being conducted.

15. An apparatus as recited in claim 9, wherein the advertiser's assets can be display on computerized watch screen when a peer-to-peer communication of being conducted.

16. An apparatus as recited in claim 9, wherein the advertiser's assets can be display on computerized glasses when a peer-to-peer communication of being conducted.
